(19) United States
(12) Patent Application Publication
(10) Pub. No.: US 2011/0045447 A1
(43) Pub. Date: Feb. 24, 2011

(54) METHOD FOR PROVIDING DATA FOR LEARNING CHINESE CHARACTER

(75) Inventor: Seong Woo Kim, Seoul (KR)

Correspondence Address: THE NATH LAW GROUP, 112 South West Street, Alexandria, VA, 22314, US

(73) Assignee: EDUFLO CO., LTD, Seoul (KR)

(21) Appl. No.: 12/990,369

(22) PCT Filed: Dec. 30, 2008
(86) PCT No.: PCT/KR08/07803

§ 371 Date: Oct. 29, 2010

(30) Foreign Application Priority Data
May 7, 2008 (KR) 10-2008-0042202

(51) Int. Cl. G09B 19/00

(52) U.S. Cl. 434/167

(57) ABSTRACT

A method for providing a data for learning a Chinese character wherein the data for learning the Chinese character is provided in response to a user input within a computer screen to facilitate a learning of the Chinese character are disclosed.

### CROSS-REFERENCE TO RELATED APPLICATIONS

This is a National Phase Application filed under 35 U.S.C. 371 as a national stage of PCT/KR2008/007803, filed on Dec. 30, 2008, an application claiming foreign priority benefits under 35 U.S.C. 119 of Korean Patent Application No. 10-2008-0042202, filed on May 7, 2008, the content of each of which is hereby incorporated by reference in its entirety.

### TECHNICAL FIELD

The present invention relates to a method for providing a data for learning a Chinese character, and more particularly, to a method for providing a data for learning a Chinese character wherein the data for learning the Chinese character is provided in response to a user input within a computer screen to facilitate a learning of the Chinese character.

### BACKGROUND ART

An ideograph is a character for conveying a meaning. While a phonetic symbol is a character representing a human voice, the ideograph has the meaning and a pronunciation. Therefore, learning the ideograph is much more difficult than learning the phonetic symbol. The Chinese character is one example of the ideograph.

70% of Korean vocabulary is originated from the Chinese character. Therefore, learning Chinese is useful for expanding Korean vocabulary and understanding an accurate meaning thereof.

In addition, due to a rapid growth of an economy of China, an interest in the Chinese character is increasing. Particularly, some colleges provide additional points for students who have passed a Chinese language qualifying examination. Some companies and public institutions requires a certain level of knowledge of the Chinese characters for an applicants thereof.

As described above, while an importance of learning the Chinese character is increasing, the Chinese character is very difficult to learn. The number of the Chinese character that has to be learned is very large because the Chinese character is the ideograph. Moreover, the meaning and the pronunciation of the Chinese character have to be memorized. Since the learning of the Chinese character is carried out by writing and memorizing the Chinese character repeatedly, it is very difficult for the user to learn the Chinese character.

As an information communication network progresses, a method for learning the Chinese character on-line has been developed. However, the method for learning the Chinese character online is merely an embodiment of a method for learning the Chinese character off-line.

That is, the method for learning the Chinese character off-line is not much different from that of on-line in a content, an effect and a motivation.

### DISCLOSURE

### Technical Problem

It is an object of the present invention to provide a method for providing a data for learning a Chinese character wherein the data for learning the Chinese character is provided on a computer screen in response to a user input to facilitate a learning of Chinese characters by the user.

### Technical Solution

There is provided a method for providing a data for learning Chinese characters, comprising steps of: (a) displaying a Chinese character to be learned in a first color; (b) receiving a user input; (c) displaying at least a portion of the Chinese character to be learned in a second color based on the user input; and (d) ceasing displaying the Chinese character to be learned when an entirety of the Chinese character to be learned is displayed in the second color.

Preferably, the method in accordance with the present invention may further comprise, prior to carrying out the step (a): (e) generating a Chinese character database containing a plurality of the Chinese characters; and (f) extracting the Chinese character to be learned from the Chinese character database.

Preferably, the step (f) comprises extracting the Chinese character to be learned based on a user level.

Preferably, the method in accordance with the present invention may further comprise (g) extracting, based on an image and a user selection input of the image, the Chinese character to be learned associated with the image prior to carrying out the step (a).

Preferably, the step (a) comprises (a-1) displaying an outline of the Chinese character to be learned.

Preferably, the step (a) comprises (a-2) displaying the Chinese character to be learned in a predetermined area.

Preferably, the predetermined area is dynamically movable, and the step (a-2) comprises displaying the Chinese character to be learned to correspond to the predetermined area moving dynamically.

Preferably, the step (b) comprises receiving the user input via a keyboard or a mouse.

Preferably, the step (c) comprises (c-1) displaying at least the portion of the Chinese character to be learned in the second color based on a user level.

Preferably, the step (c) comprises (c-2) displaying at least the portion of the Chinese character to be learned in an order of a stroke of the Chinese character to be learned.

Preferably, the method in accordance with the present invention may further comprise displaying at least one of a meaning and a pronunciation of the Chinese character to be learned while carrying out the step (c).

Preferably, the method in accordance with the present invention may further comprise outputting at least one of a meaning and a pronunciation of the Chinese character to be learned via a voice while carrying out the step (c).

Preferably, the method in accordance with the present invention may further comprise (h) managing how many times the Chinese character to be learned is learned.

Preferably, the step (h) comprises (h-1) increasing a number of times by one after carrying out the steps (a) through (d).

Preferably, the method in accordance with the present invention may further comprise (i) storing the Chinese character to be learned in a learned Chinese character database when the number of times is equal to or larger than a predetermined value.

Preferably, the method in accordance with the present invention may further comprise inspecting whether the portion of the Chinese character to be learned is included in a learned Chinese character database while carrying out the step (c).

Preferably, the method in accordance with the present invention may further comprise displaying the portion in the second color or a third color when the portion of the Chinese character to be learned is included in the learned Chinese character database while carrying out the step (c).

Preferably, the method in accordance with the present invention may further comprise displaying at least one of a meaning and a pronunciation of the Chinese character to be learned while carrying out the step (c) when the portion of the Chinese character to be learned is included in the learned Chinese character database.

Preferably, the method in accordance with the present invention may further comprise outputting at least one of a meaning and a pronunciation of the Chinese character to be learned via a voice while carrying out the step (c) when the portion of the Chinese character to be learned is included in the learned Chinese character database.

Preferably, the method in accordance with the present invention may further comprise (j) adjusting a user level in response to the user input.

Preferably, the method in accordance with the present invention may further comprise extracting an element Chinese character of the Chinese character to be learned from an image and a user selection input of the image while carrying out the step (c).

Preferably, the method in accordance with the present invention may further comprise displaying the element Chinese character in the second color or a third color while carrying out the step (c).

### ADVANTAGEOUS EFFECTS

In accordance with the present invention, the data for learning the Chinese character is provided on the computer screen in response to the user input to facilitate the learning of the Chinese character by the user.

### DESCRIPTION OF DRAWINGS

FIG. 1 is a flow diagram illustrating a method for providing a data for learning a Chinese character in accordance with the present invention.

FIG. 2 is a flow diagram illustrating a step of managing how many times the Chinese character to be learned is learned in accordance with the present invention.

FIG. 3 is a flow diagram illustrating a step of displaying Chinese character to be learned in accordance with the present invention.

FIG. 4 is a diagram illustrating an example wherein a Chinese character to be learned is displayed in a first color using a computer screen in accordance with the present invention.

FIG. 5 is a diagram illustrating an example wherein at least a portion of a Chinese character to be learned is displayed in a second color in accordance with the present invention.

FIG. 6 is a diagram exemplifying an order of stroke of a Chinese character to be learned in accordance with the present invention.

FIG. 7 is a diagram exemplifying an example wherein at least one of a meaning and a pronunciation of Chinese character to be learned is displayed or outputted via a voice in accordance with the present invention.

FIG. 8 is a diagram exemplifying an example wherein a display of a Chinese character to be learned is ceased when the Chinese character to be learned is filled with a second color in accordance with the present invention.

FIG. 9 is a diagram exemplifying an example wherein a number of times the Chinese character to be learned is learned is managed in accordance with the present invention.

FIG. 10 is a diagram exemplifying an example wherein a Chinese character which is already learned is included in a Chinese character to be learned as a portion thereof in accordance with the present invention.

FIG. 11 is a diagram exemplifying an example wherein a Chinese character which is already learned is displayed when the Chinese character which is already learned is included in a Chinese character to be learned as a portion thereof in accordance with the present invention.

FIG. 12 is a diagram exemplifying an example wherein a Chinese character to be learned which is associated with an image is extracted in accordance with the present invention.

FIG. 13 is a diagram exemplifying an example wherein an element Chinese character is extracted in accordance with the present invention.

### MODE FOR INVENTION

A method for providing a data for learning a Chinese character in accordance with the present invention will be described in detail with reference to accompanying drawings.

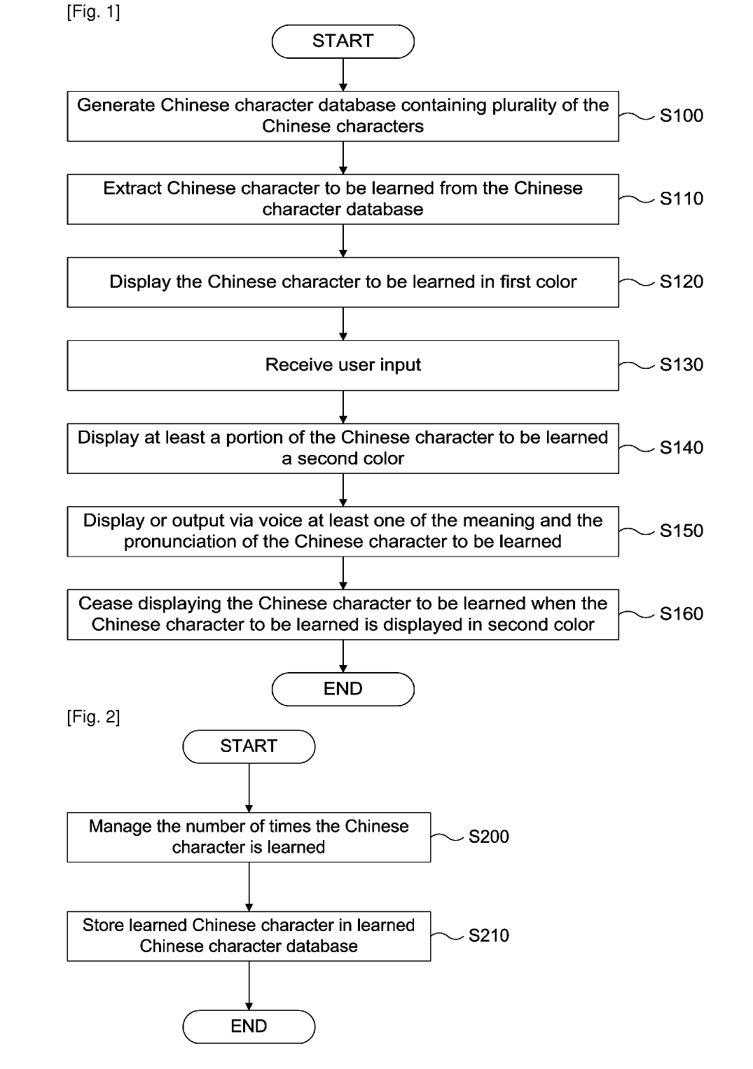

FIG. 1 is a flow diagram illustrating a method for providing a data for learning a Chinese character in accordance with the present invention.

Referring to FIG. 1, a Chinese character database containing a plurality of the Chinese characters is generated (S100).

Thereafter, a Chinese character to be learned is extracted from the Chinese character database (5110).

Thereafter, the Chinese character to be learned is displayed in a first color (S120).

The method in accordance with the present invention may be embodied through a computer screen. Particularly, the method in accordance with the present invention may be embodied by associating with a computer game.

The computer game may be an off-line game executed independently on a computer or an on-line game executed by connecting to a server via a network. The on-line game may be MMORPG (Massively Multiplayer Online Role-Playing Game) wherein multiple users connect to a game providing server simultaneously.

FIG. 4 is a diagram illustrating the step S120 wherein the Chinese character to be learned is displayed in the first color using the computer screen. Referring to FIG. 4, a user character 100, a monster character 200 and the Chinese character to be learned are displayed on the computer screen. The Chinese character to be learned shown in FIG. 4 is [symbol] denoted as reference numeral 300, which means a dog pronounced as “ki [symbol] n” in Korean, “qu\check{a}n” in Chinese and “ken” in Japanese.

The user character 100 is a character corresponding to a player of the computer game generated within the computer game.

The monster character 200 is a character that interacts with the user character 100 within the computer game. For instance, the monster character 200 has a health point. When the health point of the monster character 200 is exhausted by an attack of the user character 100, the monster character 200 also expires. In addition, when a health point of the user character 100 is exhausted by an attack of the monster character 200, the user character 100 also expires.

Again referring to FIG. 4, the Chinese character to be learned is displayed in the first color on the computer screen in the step S120.

The Chinese character to be learned, i.e., the Chinese character [symbol] 300 is displayed in the first color in a predetermined area.

As shown in FIG. 4, the Chinese character [symbol] 300 is displayed within a boundary of the monster character 200 of the computer game.

In addition, the Chinese character to be learned may be displayed in the first color other than the inside of the monster character 200.

Since the monster character 200 may move dynamically in the computer screen, the Chinese character to be learned may be displayed to correspond to the movement of the monster character 200.

On the other hand, an outline of the Chinese character to be learned may be displayed in the step S120. When colors around the Chinese character to be learned are all different, the Chinese character to be learned displayed in the first color may not be distinguishable from the colors around the Chinese character to be learned. Therefore, the outline of the Chinese character to be learned may be displayed. It is preferable that a color of the outline differs from the first color.

Referring back to FIG. 1, a user input is received (S130).

When the present invention is embodied as the computer game, the user input from the user for controlling the user character 100 may be received from a keyboard, a mouse or a joystick. For instance, the user may use arrow keys of the keyboard to control the user character 100 and also use predetermined keys such as CTLR key to control the user character 100 to attack the monster character 200.

In addition, the user input may be received in the step S130 in order to display the Chinese character to be learned in a second color even when embodied as something other than the computer game.

Again referring to FIG. 1, at least a portion of the Chinese character to be learned is displayed in the second color based on the user input (S140). It is preferable that the second color differs from the first color.

The user may pay attention to the Chinese character to be learned when at least the portion of the Chinese character to be learned is displayed in the second color.

FIG. 5 is a diagram illustrating an example wherein at least the portion of the Chinese character to be learned is displayed in the second color in accordance with the method of the present invention.

In case of a conventional computer game, the health point of the monster character 200 is displayed as a bar. However, in accordance with the present invention, the health point of the monster character 200 may be displayed as the Chinese character to be learned, i.e. the Chinese character “ [symbol] ” 300 as shown in FIG. 5. That is, the health point of the monster character 200 is displayed as the Chinese character “ [symbol] ” 300 and at least the portion of the Chinese character “ [symbol] ” 300 is displayed in the second color as the health point of the monster character 200 changes.

When the user input for controlling the user character 100 to attack the monster character 200 is received in the step S130, the health point of the monster character 200 should be decreased according to the attack in the step S140. The portion 310 of the Chinese character [symbol] 300 is displayed in the second color in order to show that the health point of the monster character 200 is reduced.

Since the user pays attention to the Chinese character to be learned, i.e. the Chinese character [symbol] 300 in order to check the health point of the monster character 200, the Chinese character to be learned may be effectively learned.

On the other hand, displaying at least the portion of the Chinese character to be learned in the second color in the step S140 may be carried out according on a user level. The user level may be an accumulated experience value of the user character 100 of the computer game. For instance, the user level may be used to set an attack power when the user character 100 attacks the monster character 200. The portion of the Chinese character to be learned displayed as the second color when the user level is low may be smaller than that of the Chinese character to be learned displayed as the second color when the user level is high.

Alternately, the user level may be a learning level of the user. The user level may be determined by checking the learning level of the user in advance when the method in accordance with the present invention is embodied as something other than the computer game. The user level may be assumed to be high when the learning level of the user is high.

As described above, the portion of the Chinese character to be learned displayed as the second color when the user level is low may be smaller than that of the Chinese character to be learned displayed as the second color when the user level is high.

In the step S140, at least the portion of the Chinese character to be learned is displayed in the second color according to an order of strokes of the Chinese character to be learned.

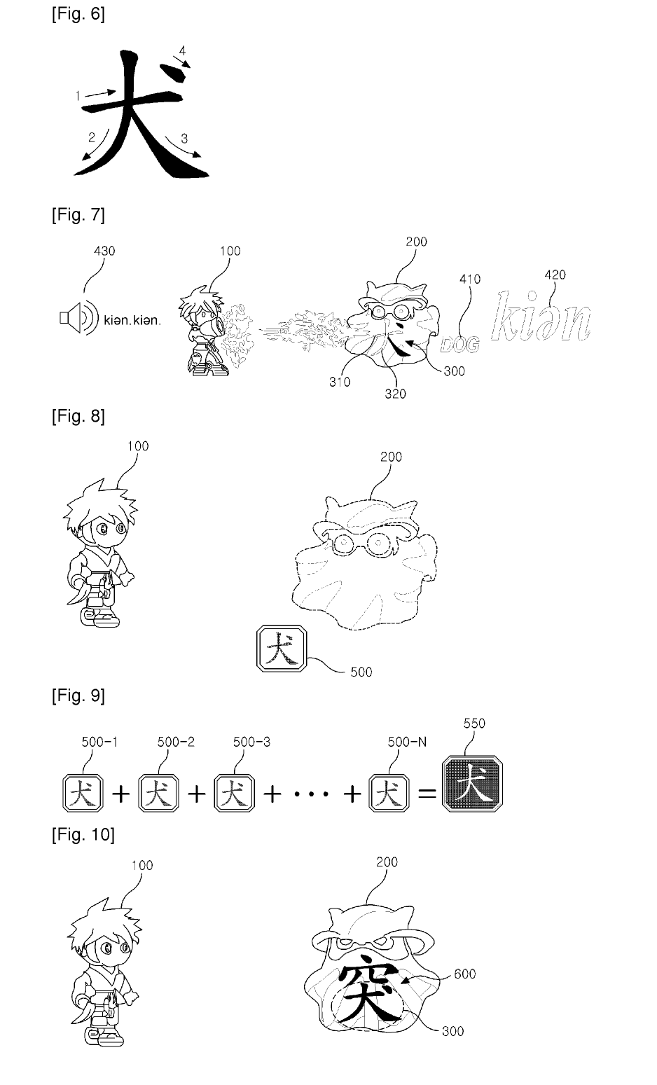

FIG. 6 is a diagram exemplifying an order of strokes of the Chinese character to be learned in accordance with the present invention.

Referring to FIG. 6, the Chinese character [symbol] 300, which is the Chinese character to be learned, is constituted by four strokes.

The Chinese character [symbol] 300 comprises the four strokes denoted as arrows 1 through 4. When writing the Chinese character [symbol] 300, a first stroke is written in a direction of the arrow 1 and a second stroke is then written in a direction of the arrow 2. Thereafter, a third stroke is written in a direction of the arrow 3 and a fourth stroke is then written in a direction of the arrow 4.

The order of the strokes is very significant in learning the Chinese character. Therefore, the Chinese character to be learned is displayed in the second color according to the order of strokes in the step S140 for the user to learn the order.

Thereafter, at least one of the meaning and the pronunciation of the Chinese character to be learned may be displayed or outputted via a voice while carrying out the step S140 (S150).

The meaning and the pronunciation of the Chinese character should be learned as well as the shape thereof. Therefore, the meaning and the pronunciation of the Chinese character to be learned may be displayed on the screen and outputted via the voice in order for to facilitate learning of the meaning and the pronunciation of the Chinese character to be learned.

FIG. 7 is a diagram exemplifying an example wherein at least one of the meaning and the pronunciation of the Chinese character to be learned is displayed or outputted via the voice in accordance with the present invention.

The meaning of the Chinese character [symbol] 300 is “dog” and is pronounced as “ki [symbol] ” in Korean, “qu\check{a}n” in Chinese and “ken” in Japanese.

When at least the portion of the Chinese character [symbol] 300 is displayed in the second color, at least one of the pronunciations “ki [symbol] n”, “qu\check{a}n” and “ken” may be displayed or outputted via the voice.

For instance, the meaning of the Chinese character to be learned may be displayed and the pronunciation thereof may be outputted via voice simultaneously.

In addition, the pronunciation may be outputted via the voice and both the pronunciation and the meaning may be displayed periodically. Accordingly, the user may see the shape of the Chinese character and see and hear the pronunciation or the meaning thereof simultaneously.

As shown in FIG. 7, the first stroke 310 of the Chinese character [symbol] 300 is displayed in the second color when the user character 100 attacks the monster character 200 once. In response to the first stroke 310 displayed in the second color, the meaning the Chinese character [symbol] 300, i.e. dog denoted as a reference numeral 410, is displayed. At least one of the pronunciations “ki [symbol] n”, “qu\check{a}n” and “ken” is also displayed denoted as a reference numeral 420. In addition, the pronunciations “ki [symbol] n”, “qu\check{a}n” and “ken” is outputted via the voice denoted as a reference numeral 430.

The step S150 may be carried out to correspond to the step S140.

That is, the step S150 may be carried out when each of the first stroke through the fourth stroke of the Chinese character [symbol] 300 is displayed in the second color.

Referring back to FIG. 1, when an entirety of the Chinese character to be learned is displayed in the second color, the display of the Chinese character to be learned is ceased (S160).

At least the portion of the Chinese character to be learned is displayed in the second color through the steps S130 and S140. When the steps S130 and S140 are carried out repeatedly, which means that the Chinese character to be learned is exposed to the user repeatedly, such that the entirety of the Chinese character to be learned is filled with the second color, the Chinese character to be learned may be assumed to be learned by the user.

FIG. 8 is a diagram exemplifying an example wherein the display of the Chinese character to be learned is ceased when the Chinese character to be learned is filled with the second color in accordance with the present invention.

Referring to FIG. 8, the display of the Chinese character to be learned displayed within the boundary of the monster character 200, the Chinese character [symbol] 300 of FIG. 7 for example is ceased.

For instance, when the monster character 200 of the computer game is repeatedly attacked through the user input by the user, the health point of the monster character 200 is reduced to zero, resulting in a termination of the monster character 200. A Chinese character item 500 for the Chinese character [symbol] 300 may be outputted in response to the termination of the monster character 200. As shown in FIG. 8, the Chinese character item 500 may be displayed at a lower portion of the computer screen after the monster character 200 is terminated. The accumulated experience value, i.e. the user level may be increased by obtaining the Chinese character item 500 in the computer game.

FIG. 2 is a flow diagram illustrating a step of managing how many times the Chinese character to be learned is learned in accordance with the present invention.

Referring to FIG. 2, how many times the Chinese character to be learned is learned is managed after carrying out the step S160 (S200).

When the entirety of the Chinese character to be learned is filled with the second color, the Chinese character to be learned may be assumed to be learned by the user due to a sufficient exposure of the Chinese character to be learned to the user.

That is, the number of times the Chinese character to be learned is learned is counted in the step S200.

When the steps S120 through S160 are carried out N times, it may be assumed that the Chinese character to be learned N times.

The number is increased by one when the steps S120 through 5160 are carried out.

FIG. 9 is a diagram exemplifying an example wherein the number of times the Chinese character to be learned is learned is managed in accordance with the present invention.

The Chinese character item 500 of FIG. 8 obtained by carrying out the steps S120 through S160 means that the Chinese character to be learned, i.e. the Chinese character [symbol] 300 is learned once. Therefore, when the steps S120 through S160 are carried out N times, Chinese character items 500_1 through 500_N for the Chinese character [symbol] 300 may be obtained. When the number of N Chinese character items 500 for the Chinese character [symbol] 300 are obtained, the Chinese character to be learned, i.e. the Chinese character [symbol] 300 may be assumed to be sufficiently exposed to and learned by the user. Therefore, a learning completion item 550 representing the learning process is complete is generated. Whether the learning of the Chinese character [symbol] 300 is complete may be checked through the learning completion item 550.

Thereafter, the Chinese character to be learned is stored in a learned Chinese character database when the number of times is equal to or larger than a predetermined value (S210).

The learned Chinese character database stores the Chinese character to be learned that is assumed to be learned by the user.

When the Chinese character to be learned that is assumed to be learned, i.e. a learned Chinese character is stored separately, a flexibility in providing the data is improved.

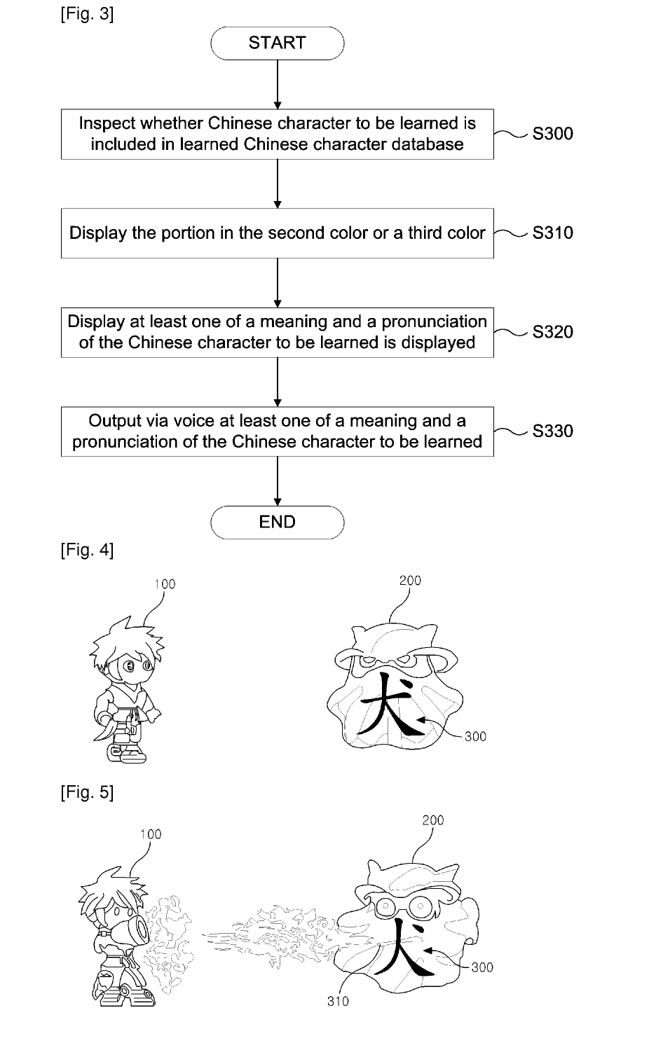

FIG. 3 is a flow diagram illustrating a step of displaying Chinese character to be learned in accordance with the present invention.

The Chinese character comprises a composite character wherein characters are combined to create a new character. Therefore, when the learned Chinese character is stored, learning a new character including the learned Chinese character may be facilitated. For instance, a Chinese character [symbol] is the composite character of Chinese characters [symbol] and [symbol] . Therefore, when the user already has a knowledge of the Chinese character [symbol] or [symbol] , learning the Chinese character [symbol] may be facilitated.

Referring to FIG. 3, while carrying out the step S140, whether the Chinese character to be learned is included in the learned Chinese character database is inspected (S300).

FIG. 10 is a diagram exemplifying an example wherein the learned Chinese character is included in the Chinese character to be learned as a portion thereof in accordance with the present invention.

Referring to FIG. 10, the Chinese character to be learned, i.e. a Chinese character [symbol] 600 is displayed within the boundary of the monster character 200. A meaning of the Chinese character [symbol] 600 is “collide”. The Chinese character [symbol] 600 is pronounced as “dol” in Korean, “tū” in Chinese and “totsu” in Japanese.

In addition, the Chinese character [symbol] 600 includes the Chinese character [symbol] 300. When the Chinese character [symbol] 300 is already included in the learned Chinese character database, the learning of the Chinese character [symbol] 600 may be facilitated.

Thereafter, when the portion of the Chinese character to be learned is included in the learned Chinese character database, the portion is displayed in the second color or a third color (S310). It is preferable that the third color differs from the first and the second colors.

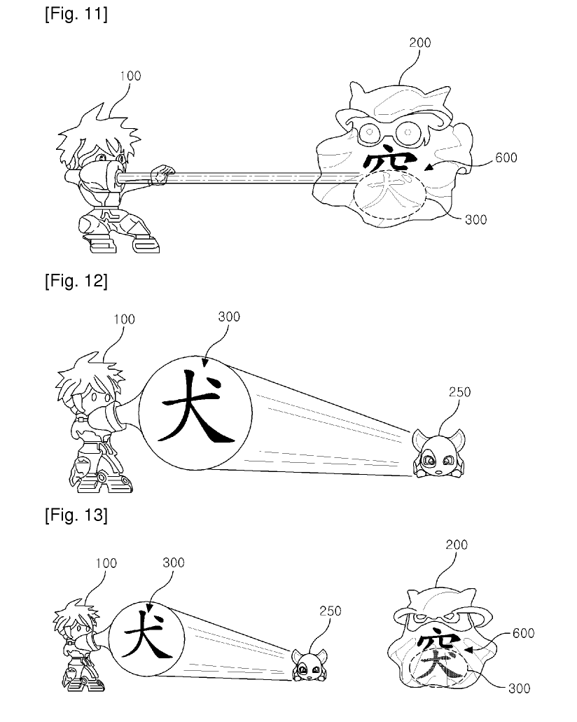

FIG. 11 is a diagram exemplifying an example wherein the learned Chinese character is displayed when the learned Chinese character is included in the Chinese character to be learned as the portion thereof in accordance with the present invention.

Referring to FIG. 11, the Chinese character [symbol] 600 is displayed within the boundary of the monster character 200, and includes the learned Chinese character [symbol] 300. The learned Chinese character [symbol] 300 is displayed in a color that differs from a rest of the Chinese character [symbol] 600 by the user input.

Thereafter, at least one of a meaning and a pronunciation of the Chinese character to be learned is displayed when the Chinese character to be learned is included in the learned Chinese character database (S320).

Thereafter, at least one of a meaning and a pronunciation of the Chinese character to be learned is outputted via a voice when the Chinese character to be learned is included in the learned Chinese character database (S330).

Although not shown in FIG. 1, the method in accordance with the present invention may further include a step of adjusting the user level in response to the user input.

In the step S140, at least the portion of the Chinese character to be learned is displayed in the second color. Therefore, the Chinese character to be learned is exposed to the user. When the user input is received, the user level is increased. Particularly, when the display of the Chinese character to be learned is ceased in the step S160, the Chinese character to be learned may be assumed to be sufficiently exposed and learned. As a result, the user level is increased. The Chinese character to be learned may be selected based on the user level.

The extraction of the Chinese character to be learned in the step S110 may be carried out based on the user level.

That is, when the user level is high, a more difficult Chinese character may be extracted as the Chinese character to be learned. When the user level is low, a less difficult Chinese character may be extracted as the Chinese character to be learned

In addition, the Chinese character to be learned may be extracted based on an image.

Although not shown in FIG. 1, the method in accordance with the present invention may further include a step of extracting the Chinese character to be learned associated with the image based on the image and a user selection input for the image.

FIG. 12 is a diagram exemplifying an example wherein a Chinese character to be learned that is associated with the image is extracted in accordance with the present invention. Referring to FIG. 12, the user character 100 and an image of a dog 250 are shown. When the user selection input for the image of the dog 250 is received, the Chinese character [symbol] 300 which represents “dog” may be extracted. The extracted Chinese character [symbol] 300 may be displayed within the boundary of the monster character as shown in FIG. 4.

A principle of constituting the Chinese character may be learned by extracting the Chinese character to be learned based on the image.

Although not shown in FIG. 1, the method in accordance with the present invention may further comprise a step of extracting an element Chinese character of the Chinese character to be learned based on the image and the user selection input of the image while carrying out the step S140.

FIG. 13 is a diagram exemplifying an example wherein the element Chinese character is extracted in accordance with the present invention.

Referring to FIG. 13, the user character 100, the monster character 200 and the image of the dog 250 are shown. The Chinese character [symbol] 600 is displayed in the monster character 200. In addition, the Chinese character [symbol] 300 is included in the Chinese character [symbol] 600. Regardless that the user already learned the Chinese character [symbol] 300 or not, the image of the dog 250 may be extracted from the Chinese character [symbol] 300 when the user selection input for the image of the dog 250 is received.

An entirety of the Chinese character [symbol] 300 may be displayed in the second color or the third color in the Chinese character [symbol] 600 through the user input.

Considering the fact that the element Chinese character originates from objects of nature, the element Chinese characters [symbol] , [symbol] , [symbol] and [symbol] may be extracted from images of a water, a tree, a moon and a sun, respectively. When the element Chinese characters are used, the user may learn the Chinese character in a more enjoyable way.

As described above, the method in accordance with the present invention may facilitate the learning of the Chinese character by associating with the computer game.

While the present invention has been particularly shown and described with reference to the preferred embodiment thereof, it will be understood by those skilled in the art that various changes in form and details may be effected therein without departing from the spirit and scope of the invention as defined by the appended claims.

### INDUSTRIAL APPLICABILITY

In accordance with the present invention, the data for learning the Chinese character is provided on the computer screen in response to the user input to facilitate the learning of the Chinese character by the user.

Particularly, since the Chinese character to be learned is displayed according to the order of the strokes according to the user input, the user may visually learn the Chinese character to be learned. Moreover, the user may learn the meaning and the pronunciation by displaying the meaning and the pronunciation or outputting the meaning and the pronunciation via the voice.

In addition, various Chinese characters may be learned based on the learned Chinese character.

Moreover, the principle of constituting the Chinese character may be learned by extracting the Chinese character to be learned based on the image.

1. A method for providing a data for learning Chinese characters, comprising steps of:
(a) displaying a Chinese character to be learned in a first color;
(b) receiving a user input;
(c) displaying at least a portion of the Chinese character to be learned in a second color based on the user input; and
(d) ceasing displaying the Chinese character to be learned when an entirety of the Chinese character to be learned is displayed in the second color.

2. The method in accordance with claim 1, further comprising, prior to carrying out the step (a):
(e) generating a Chinese character database containing a plurality of the Chinese characters; and
(f) extracting the Chinese character to be learned from the Chinese character database.

3. The method in accordance with claim 2, wherein the step (f) comprises extracting the Chinese character to be learned based on a user level.

4. The method in accordance with claim 1, further comprising (g) extracting, based on an image and a user selection input of the image, the Chinese character to be learned associated with the image prior to carrying out the step (a).

5. The method in accordance with claim 1, wherein the step (a) comprises (a-1) displaying an outline of the Chinese character to be learned.

6. The method in accordance with claim 1, wherein the step (a) comprises (a-2) displaying the Chinese character to be learned in a predetermined area.

7. The method in accordance with claim 6, wherein the predetermined area is dynamically movable, and the step (a-2) comprises displaying the Chinese character to be learned to correspond to the predetermined area moving dynamically.

8. The method in accordance with claim 1, wherein the step (b) comprises receiving the user input via a keyboard or a mouse.

9. The method in accordance with claim 1, wherein the step (c) comprises (c-1) displaying at least the portion of the Chinese character to be learned in the second color based on a user level.

10. The method in accordance with claim 1, wherein the step (c) comprises (c-2) displaying at least the portion of the Chinese character to be learned in an order of a stroke of the Chinese character to be learned.

11. The method in accordance with claim 1, further comprising displaying at least one of a meaning and a pronunciation of the Chinese character to be learned while carrying out the step (c).

12. The method in accordance with claim 1, further comprising outputting at least one of a meaning and a pronunciation of the Chinese character to be learned via a voice while carrying out the step (c).

13. The method in accordance with claim 1, further comprising (h) managing how many times the Chinese character to be learned is learned.

14. The method in accordance with claim 13, wherein the step (h) comprises (h-1) increasing a number of times by one after carrying out the steps (a) through (d).

15. The method in accordance with claim 13, further comprising (i) storing the Chinese character to be learned in a learned Chinese character database when the number of times is equal to or larger than a predetermined value.

16. The method in accordance with claim 1, further comprising inspecting whether the portion of the Chinese character to be learned is included in a learned Chinese character database while carrying out the step (c).

17. The method in accordance with claim 16, further comprising displaying the portion in the second color or a third color when the portion of the Chinese character to be learned is included in the learned Chinese character database while carrying out the step (c).

18. The method in accordance with claim 16, further comprising displaying at least one of a meaning and a pronunciation of the Chinese character to be learned while carrying out the step (c) when the portion of the Chinese character to be learned is included in the learned Chinese character database.

19. The method in accordance with claim 16, further comprising outputting at least one of a meaning and a pronunciation of the Chinese character to be learned via a voice while carrying out the step (c) when the portion of the Chinese character to be learned is included in the learned Chinese character database.

20. The method in accordance with claim 1, further comprising (j) adjusting a user level in response to the user input.

21. The method in accordance with claim 1, further comprising extracting an element Chinese character of the Chinese character to be learned from an image and a user selection input of the image while carrying out the step (c).

22. The method in accordance with claim 21, further comprising displaying the element Chinese character in the second color or a third color while carrying out the step (c).

23. (canceled)
